(19) United States
(12) Patent Application Publication
(10) Pub. No.: US 2014/0279190 A1
(43) Pub. Date: Sep. 18, 2014

(54) RECOMMENDED CONTENT GENERATION AND DISTRIBUTION

(71) Applicant: SIMPLERELEVANCE INC., Chicago, IL (US)

(72) Inventors: Erik Severinghaus, Chicago, IL (US); Eli Albert, Chicago, IL (US); Gabriel Gaster, Chicago, IL (US)

(73) Assignee: SimpleRelevance Inc., Chicago, IL (US)

(21) Appl. No.: 13/803,279

(22) Filed: Mar. 14, 2013

(51) Int. Cl. G06Q 30/06

(52) U.S. Cl. CPC G06Q 30/0631
USPC 705/26.7

(57) ABSTRACT

A system to receive external data from one or more data sources, process the external data, determine available items of a first client, and retrieve user transactions associated with a targeted user. User attributes of the targeted user and item attributes of the available items are paired and the mean purchasing frequency for each of the pairs is determined. Global transactions of a population of users are analyzed to determine the standard deviation and a global mean purchasing frequency. A relevance score for each user attribute and item attribute pair is calculated. The item relevance score for each available item is determined based on the relevance score for each of the user attribute and item attribute pairs. Available items of the first client are selected based upon calculated relevance scores.

### BACKGROUND

Many companies seek to directly target messaging to users using online communication mediums. Methods of communication include emails, websites, and sponsored content on third party websites. Companies benefit by customizing messages to each user so that a message received by a user is highly relevant to that user as compared to a generic message sent to all users. However, it can be very time consuming and cost-prohibitive for companies to customize its messaging for each targeted user.

### SUMMARY

The present disclosure generally provides recommended content generation and distribution. In general, one aspect of the subject matter described in this specification can be embodied in methods and systems for generating and distributing recommended content. External data is received from one or more data sources at a computing device. The computing device processes the external data. The processed data is stored at the computing device.

The computing device determines available items of a first client. Each item has item attributes. The computing device retrieves user transactions and user attributes associated with a targeted user, where the user attributes include a user identifier. Each user transaction comprises an item identifier and a user identifier. User transactions comprise one or more transactions involving a second client different than the first client.

Each user attribute of the targeted user and each item attribute of the available items are paired. The computing device determines the mean purchasing frequency for each of the pairs of user attributes and item attributes. The computing device retrieves one or more user attribute values of the targeted user and, for each of the user attribute values, the computing device retrieves global transactions of a population of users that have the same user attribute value as the targeted user for one or more user attribute values.

The computing device determines the standard deviation and a global mean purchasing frequency for each of the pairs of user attribute and item attribute from each of the global transactions. A relevance score for each of the pairs of the user attribute and item attribute is calculated based at least on the user mean purchasing frequency, the global mean purchasing frequency, and the standard deviation. The item relevance score for each available item is determined based upon one or more relevance scores that match an item attribute of the available item. One or more available items of the first client are selected based upon relevance scores of the available items.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an example computing device.

FIG. 2 is a block diagram of a system with a server receiving inputs from a variety of sources and generating content according to a representative embodiment.

FIG. 3 is a block diagram of a server according to a representative embodiment.

FIG. 4 is a block diagram of a recommendation engine, data sources made available to the example recommendation engine, and a content generator according to a representative embodiment.

FIG. 5 is a flow diagram of a method for generating and sending targeted emails with recommended content for the targeted user in a representative embodiment.

FIG. 6 is a flow diagram of a method for responding to a micro-blog post with automatically generated micro-blog post reply with recommended content in a representative embodiment.

FIG. 7 is a flow diagram of a method for providing recommended content for display on a webpage in a representative embodiment.

### DETAILED DESCRIPTION

The present description is directed to a system that gathers information about clients, users, items, and transactions. The system can use the gathered information to generate content targeted to specific users. For example, the system can provide an interface that allows a client to request an email be sent to a user. The system can gather user information, client data, and data available from third party data providers. The raw data from these various data sources can be processed and combined to allow the system to generate content that is relevant to the user. The system makes it easier for clients to communicate with users using targeted content.

FIG. 1 is a block diagram of a computing device 100 which can be used to implement the systems and methods in accordance with the implementations described herein, as either a client or as a server or plurality of servers. A description of the components of FIG. 1 follow the implementations below.

Recommendation Server

FIG. 2 is a block diagram depicting a system 200 with a server 202, a social media data source 204, a third party data source 206, a client business data source 208, a client content tagging source 210, and generated content 212. A social media data source 204 can be any system with private, semi-private, public, or any combination thereof, social networks. In an embodiment, a social media data source 204 can contain data related to blog posts made by users. In another embodiment, a social media data source 204 can contain data related to friends of a user. In another embodiment, a social media data source 204 can contain data related to product or service reviews made by users. For example, an e-commerce platform can allow users of the platform to post reviews or other commentary related to a product.

A third party data source 206 can be any system that collects data about users, products, transactions, etc. For example, a third party data source 206 can collect data about users without explicit interaction from a user. In another embodiment, a third party data source 206 can collect the political donation history based on a first and last name of a user. Data from various third party data sources can be combined to provide aggregated data about users, products, transactions, etc. As another example, a third party data source 206 can collect geographic information related to an IP address.

A client business data source 208 can be any data source made available by a client of the system 200. In an embodiment, a client can establish an e-commerce store. The e-commerce store can be hosted on a server maintained by the client or it can be hosted virtually. The client system can be comprised of one or more data sources. The data sources can collect and maintain data related to, for example, inventory, users, user purchasing history, user demographics, advertisements shown to a user, products suggested to a user, products that a user has clicked on, and so forth. The client can expose one or more client business data sources 208 to the server 202. The server 202 can be connected to client business data sources 208 associated with different clients.

A client content tagging source 210 can be any code placed in external content. In an embodiment, the server 202 can provide a client with a code snippet (i.e., a tag) that the client can place on each page of its e-commerce store. The code snippet can then be executed each time a user views a page. Thus, for example, the code snippet can report the number of times a user visited a page. The code snippet can also report additional data, for example to which area of the page did the user direct the cursor, or how much time did a user spend playing a video on a page. The code snippet can report each interaction to the server 202.

In another embodiment, generated content 212 can contain code that is executed when the content is viewed. Thus, for example, the server 202 can receive reporting on whether the user targeted by the generated content viewed the content. In another example, the server 202 can receive reporting on which area of the email the user clicked, or if the user clicked at all.

In another embodiment, the client content tagging source 210 can be maintained by the client or a third party. For example, a client can include tags from a third party advertising network on the client's website. Or the client can track the activities of their users throughout the web using third party tags. The server 202 can be granted permission to retrieve data collected by client content tagging sources 210.

The server 202 can communicate with each data source. In an embodiment, the server 202 can request data from a data source. For example, the server 202 can utilize an Application Programming Interface (API) made available by a data source. The server 202 can use the API to request and receive, in response to the request, data from the data source. In another embodiment, the server 202 can periodically receive data from a data source without first sending a request for data. For example, a data source can permit the server 202 to register as a recipient for data. If the data source identifies data that the server 202 should receive, the data source can send the data through an agreed upon protocol. In another embodiment, the server 202 can first authenticate with a data source using one or more authentication technologies. It will be obvious to one skilled in the art that a server 202 can implement any number of accepted authentication and security practices. For example, the server can choose to communicate with a data source over an SSL layer.

In another embodiment, the server 202 can implement public key encryption technology to ensure that the data received from a data source has not been tampered with. The server 202 can also, optionally, send a response to the data source that sent the data. In an embodiment, the server 202 can indicate the success or failure of the data transfer and data processing. For example, the server 202 can respond with a unique identifier related to the last entry in the data that was processed. This way, the data source can subsequently send only data that was not previously processed by the server. In another example, the server 202 can alert the data source of any data entries that failed at the data processing step. Thus, the data source can determine that the failed data should be sent again at a later time.

In another embodiment, a data source 204, 206, 208, 210, can determine that data should be sent to the server 202 based on a pre-determined rule, such as sending data at scheduled time or when a condition is met. For example, a data source can send updated data to the server every night, or a data source can send data when new data related to a user is added. In another example, the client content data source can send data when the inventory of an item is depleted. The data source can then send data to the server 202 using an agreed upon protocol. For example, the data source can construct a URL containing the data that should be sent to the server. If the amount of data is sufficiently small, the URL can contain the data in the query string. Alternatively, it can be preferable to submit a POST request, wherein the data is embedded into the body of the request. In another example, the data source can upload content to the server using an FTP protocol. It will be appreciated by one skilled in the art that any number of protocols can be established to facilitate data transfer between a data source and the server 202.

When the server receives data from a data source, it can process the received data so that the data may be stored in data structures along with data extracted from other data sources. Data structures can include, but are not limited to, databases, XML files, CSV files, etc. In an embodiment, the server can first determine if the data is structured in an expected manner. For example, the server 202 expect data from a data source to be in a particular XML format. In this example, the server can determine whether the contents are structured in a valid XML format. The server 202 can identify portions of the received data that should be stored in the server data structures. For example, the server 202 can extract key value pairs and store this data as attributes in the data structures. The server 202 can also identify data that should be modified prior to storing the data in server data structures. For example, the received data may include the mailing address of a user. The server can reduce the mailing address into component parts, such as city, state, postal code, etc. These components of the mailing address can then be stored separately within the appropriate data structures. The data structures can contain data from multiple data sources. In addition, data associated with a particular user, item, etc., can originate from multiple data sources. For example, a user's purchase history from one e-commerce platform data source can be combined with the user's social media data, review data, other e-commerce platforms. Recommendations for a particular user can, therefore, be generated based upon this aggregated data and not just data from a single data source, such as a single e-commerce platform. The processed data can be grouped into various different categories of data. In one implementation, the processed data can be grouped into a users data structure; a transactions data structure; and an items data structure.

The server 202 can use the processed data to create generated content 212 that is targeted each user. For example, the targeted generated content 212 can include information that is targeted to a user and/or can be sent at a time based upon the processed data associated with the user. Generated content 212 can include, but is not limited to, emails, recommendations, social media content, micro-blog content, web site content, etc. In one embodiment, a client can send a request to the server 202 to generate content for one or more users associated with the client. For example, a client that has an e-commerce engine can request that the server 202 create generated content 212 for one or more of their users. As a specific example, the client can request the server 202 to create generated content 212 for all users that have purchased a product from the client in the past, but not within the last sixty days.

As noted above, generated content 212 can be used for different purposes. As an example, the generated content 212 can be emails that include targeted content. The server 202 can determine what content to target to users by analyzing the processed data and determining which data is relevant to the targeted users. The server 202 can create generated content 212 based on the results of the processed data analysis. As described in greater detail below, the server 202 can determine which items of the client are most relevant to users with one or more specific attributes. The most relevant items can be incorporated into the generated content 212. In another example, the server 202 can determine, based on either data received from the client or from previously processed data, that the client is nearly out of a recommended item. The generated content can include a special message indicating that the item is almost sold out.

In another embodiment, the server 202 can periodically scan social network data sources 204 using natural language processing to identify user activity that a client wishes to respond to. The server 202 can use natural language processing to identify key phrases in the scanned social network data. For example, one key phrase can be “shopping for a car” and another key phrase can be “buying a car”. The server 202 can analyze all accessible aspects of the social media data including, but not limited to, historical user activity, and user profiles. Thus, the analyzed data from multiple users and social media data sources can be used to assign weights to each of the matching key phrases. The weight can indicate the probability that the user associated with the post will engage with messaging from a client. For example, the server 202 can determine that “buying a car” as a weight of 0.75 and “shopping for a car” has a weight of 0.25 for a client that sells new cars. Thus, a user that uses the phrase “buying a car” is more likely to engage with content from the client that sells new cars than a user that uses the phrase “shopping for a car”. The server 202 can rank micro-blog entries based on the total assigned weight with respect to a particular client. The server 202 can determine if a micro-blog entry can be targeted based on the ranking. The server 202 can additionally determine if the user associated with the micro-blog entry can be targeted with items from the particular client.

The server 202 can determine if a particular client should target the micro-blog entry based on the user attributes for the targeted user associated with the entry. For example, a targeted user can post on a micro-blog an entry stating an intention to purchase a car. The server 202 can process additional micro-blog entries by the user and any processed data related to the user (e.g., user attributes and transactions). This information can be used in conjunction with other processed data to create generated content 212 incorporating recommendations from among the client's items for the targeted user. For example, one of the items sold by the client can be a red sports car. The system 202 can determine that attributes associated with users that have purchased a red sports car can include gender is male, household income is more than $100,000, and age is between 35-45. As described in greater detail below, these attributes can be determined using data from multiple data sources. If the targeted user matches these attributes, the generated content 212 created for the user can include a red sports car.

As another example, a client can sell audio accessories for cars. The server 202 can determine that the user that made the initial micro-blog entry regarding purchasing a car can be targeted by the client selling audio accessories for cars. Based upon the processed data, the server 202 can identify users that are audiophiles. For example, reviews of audio accessories, social media information about audio accessories, and/or purchases of audio accessories, etc., can be used to determine that the user has an interest in audio accessories. The server 202, therefore, can create generated content 212 on behalf of the client to the user regarding one or more audio accessories. In one implementation, this can include posting a micro-blog response to the user's initial micro-blog entry that includes a hashtag and/or link associated with the client. For example, the link can be to a specific product of the client.

The server 202 can identify a large number of micro-blog entries that can be targeted for one or more clients. The server 202 can determine how often a client can send generated content and how often a user can be targeted by generated content. For example, once the server 202 has ranked micro-blog entries that can be targeted by a client, the server can determine which of the ranked micro-blog entries should be targeted by the client. The server 202 can limit the number of times a client engages with micro-blog entries in a particular time period, such as, but not limited to, 6 hours, 12 hours, or 24 hours. Thus, if a client can only interact with 50 micro-blog entries in a 24 hour period, the server 202 can select the top 50 ranked micro-blog entries. In another example, the server 202 can lower the ranking of a micro-blog entry if the user has already received generated content from one or more clients. For example, the server 202 can determine that a user should only receive generated content a limited number of times a day, such as 3, 5, or 10 times a day. Thus, if the user has already received generated content, for example, 5 times in the past twenty-four hours, the server 202 can remove micro-blog entries associated with the user from the rankings.

Another example of generated content is targeted web content. The server 202 can receive a request from a client to create targeted web content which can be displayed to a user. The server 202 can retrieve a general version of the web content. For example, the client can indicate that the user has requested a recommended items page. The server 202 can generate targeted web content for the user using the processed data. For example, the server 202 can promote items that are relevant to the user, or the server 202 can display different descriptions of an item based on available data. The server 202 can determine which content to promote and which to exclude based on the request from the client and previously processed data. The server 202 can return the generated content to the requesting client. In another embodiment, the server 202 can serve the page directly to the targeted user. As another example the generated content can be a list of recommended items for use in a call center. For example, the list of recommended items can be determined for a particular caller.

Data Structures

FIG. 3 is a block diagram of a server 202 with processed data 302, recommendation history 310, business rules 312, a recommendation engine 314, and a recommended content generator.

Processed data 302 can include data from data sources 204, 206, 208, 210. Data that is received from a data source 204, 206, 208, 210 is processed by the server 202 so that the data can be analyzed with data from other extracted data sources. For example, data from multiple e-commerce platforms can be aggregated. The processed data can be categorized in various ways. For example, data relating to users can be placed in a users data structure 304, data relating to items can be placed in an items data structure 308, and data about transactions can be placed in a transactions data structure 306. In one implementation, data relating to users are referred to as user attributes. For example, user attributes can include, but are not limited to, age, gender, email address, name, address, etc. As described in greater detail below, data relating to items can include item attributes, such as, but not limited to, product description, price, associated URL, etc. In addition, the items data structure 308 can include information specific to a client. For example, the items available for purchase through a client's e-commerce site can be stored in the items data structure 308. In one embodiment, the transactions data structure 306 can include data relating to a user's interaction with an item or other object. For example, a transaction can include that a user purchased a product, reviewed a product, clicked on particular URL, etc. As noted above, each of the data structures can include data from multiple data sources. Accordingly, user attributes, transactions, and items can be based upon data from various different sources.

As described above, the users data structure 304 can include information about users from the various different data sources. For example, users can include users that have registered with a client's e-commerce platform. Thus, the users data structure 304 can include the information submitted by the user as part of the registration process. A second e-commerce platform may allow a client to purchase a product without registration. In this example, the user may provide their name, email address, and address, but nothing else. This information can also be incorporated into the user data structure. Using data from multiple different data sources, users can be identified. For example, an email address can be used to identify a user across different data sources. This allows data from different data sources related to a single user can be aggregated together. Further, the server 202 can generate targeted content for a user of the second e-commerce platform based upon the information received from the first e-commerce platform. Each user that has data stored in the users data structure 304 can be associated with a user identifier, such as the user's email address, a user name, an IP address, etc.

The items data structure 308 can include information about objects that entities can interact with. As an example, an item can be a product sold by a client. A client with an e-commerce platform can have multiple products that are available for a customer to purchase. The client can retain information that describes each product, which can be processed and stored in the items data structure 308. In addition, each item can have an item identifier. For example, the client can include a stock-keeping unit number (i.e., SKU number) which uniquely identifies each product, a price for each product, the color or colors the product is available in, the dimensions of a product, or inventory size of the product, a description of the product, one or more pictures of an product, etc. The server 202 can receive this data and process the data to identify data that can be stored in items data structure 308. For example, the server 202, may store product descriptions, colors, prices, etc., for each SKU. In another example, the server 202 can receive different prices from different data sources for the same SKU. Thus, the server 202, may store the product related information in items data structure 308 with the different prices separated out by the data source. In another example, the server 202 can receive unstructured text consisting of item attributes. The server 202 can parse the unstructured text to extract item attributes. For example, the unstructured text may include a description of a shirt. The description may include an SKU, the available colors, and the available sizes. The server 202 can extract the attributes and create items for each of the available sizes and colors. The server 202 can then group the created items with the SKU, which may be shared by all color and size combinations.

The transactions data structure 306 can include interactions between users and items. In one implementation, the transactions data structure 306 can include a reference to a user, a reference to an item, and an indication of what the user's interaction was with the item. For example, the interaction can be that a user purchased a particular product. Additional information concerning a transaction can also be stored in the transactions data structure 306 or another data structure. For example, the date of a transaction, the type of transaction, the amount of the transaction, etc., can be stored in addition to the data in the transactions data structure 306. The transactions data structure 306 can also include a transaction group identifier, so that transactions that included multiple items can be identified. In the above examples, the interaction with the item can be many different types of interactions. For example, the interaction can be a purchase, a return, a rental, a gift, a click, reading an email, posting on a social media site, etc. If an item is a digital product, such as a movie, the interaction can also include information such as a user playing, pausing, fast forwarding, rewinding, or stopping the movie. In a further example, physical products that can have an online component, such as online registration, can include additional types of transactions, such as registering the product, retrieving digital content associated with the item, and so on.

In another embodiment, transactions can also include actions on a website. For example, a client platform can track customer interactions with different content on the platform. For example, an item may represent a first location for a “donate” button on a page. The server 202 can process data sources to extract transactions between users representing customers and an item representing the button. The server 202 can, for example, track the number of times users clicked on the button, move the mouse over the button, or avoided the button. For example, the button can cause the user to navigate to a URL. Additionally, the button may appear in a first location to a first user and in a second location to a second user based on webpage optimization rules. The URL may send a request to the server 202 with data related to the button, the position of the button, and the destination that the user should be directed to. The server 202 can parse the data related to the button and, if no item for the button has been created, create a new item for the button. The position of the button, the destination that the user should be directed to, and any other information that is included in the request, can be stored as item attributes for the button item. The system 102 can store a transaction for the user that clicked on the button. Thus, for example, the server 202 can determine the optimal position of a webpage object by determining the frequency of the desired action for one or more users.

The server 202 can also include recommendation history 310 that includes data related to past recommendations made by the server 202. In an embodiment, server 202 can store recommendations made to users as part of creating generated content 212. The stored recommendation history 310 can be queried by the server 202 when generating recommendations to prevent repeated recommendations of a single item.

The server 202 can also include business rules 312 that can be used to define limitations on the generated content. Business rules 312 can be determined by a client and can be input using a user interface. For example, the client can access a user interface in which the client can define business rules 312 using a scripting language. In another example, the client can be presented with a graphical user interface and can define business rules 312 using a point and click user interface. In an embodiment, business rules 312 can be configured by the client to restrict which items can be used in generated content. For example, the client can define a first business rule 312 disallowing products released more than a year ago from being included in generated content. In another example, the client can disallow items that are priced below cost from being included in generated content. The server 202 can determine whether an item matches a business rule by analyzing the item data provided by one or more clients.

In another embodiment, business rules 312 can be configured by the client to select the target sales for an item over a period of time by implementing a business rule related to the available inventory of an item. For example, the client can define a first business rule targeting one hundred unit sales over the period of a month. The server 202 can use this rule to weight items based on past performance, future expected performance, and sales target. For example, the server 202 can determine that an item has decreased transactions similar to the targeted transaction during a given month. Thus, the server 202 can determine that the number of recommendations made for the item should be increased for the given month. In another example, the server 202 may have previously processed projected sales data for an item from an external data source. The server may query projected sales for an item and may base a determination to recommend the item at least on the projected sales. In another example, the server 202 can query the number of transactions for an item. Based on how close the number is to the targeted sales, the server 202 can determine that additional recommendations are not necessary.

Recommendation Engine

The recommendation engine 314 can query processed data 302, recommendation history 310, and business rules 312 to select content for inclusion in generated content 212. The recommended content generator 316 can receive content from the recommendation engine 314 and generate targeted content.

FIG. 4 is a block diagram of a recommendation engine 314 with access to processed data 302. The recommendation engine 314 can use one or more procedures for generating recommendations. The recommendation engine 314 is illustrated with four for ranking procedures 408, 410, 412, 416. Recommendations can be based upon different portions of the processed data. For example, recommendations for a user can be based upon the transactions associated with the user; based upon user attributes of multiple users that interact with the same type of items, etc. In addition, the results of two or more of these procedures can be combined to create generated content 212.

The compare user transaction history to item attributes 408 procedure determines the relevance of an item to a targeted user based upon the user's transactions. In an embodiment, the server 202 can query the transactions data structure 306 to determine the mean frequency of user purchases for an item with a particular item attribute. The mean frequency can be calculated based on specific user attribute values. For example, if the targeted user is a male and the item being considered belongs to the category of spa services, the server can calculate the mean frequency and the standard deviation of transactions for items belonging to a category of spa services and all users who are male. Thus the server 202 can determine how frequently the average male purchases an item belonging to the spa services category. In another embodiment, the mean frequency and the standard deviation values are calculated at previous time.

In addition to calculating the mean purchasing frequency for all users with a shared user attribute, in this case male, for an item with a particular item attribute, the server 202 can calculate the mean frequency of the of transactions of the targeted user with items that have the particular item attribute. Thus, the server can determine how often the targeted user buys items belonging to the category spa services. Because the targeted user shares the same gender attribute value as the attribute value that was used to calculate the mean frequency above, the server 202 can determine the probability of the targeted user being more or less inclined to purchase items belonging to the category spa services. For example, if the mean purchasing frequency for items belonging to the category spa services for male users is one per month (Fₘₑₐₙ=1) and the standard deviation is 0.5 (StdDevₘₑₐₙ=0.5) and the purchasing frequency for the targeted user for the same items is four per month (Fᵤₛₑᵣ=4), the ranking of items belonging to the category spa services can be determined using the following equation:

$$R = \frac{{F}_{User} - {F}_{Mean}}{{StdDev}_{Mean}} ,$$

where R is the statistical relevance. Thus, in the example above, the statistical relevance for an item belonging to the spa services category for the targeted user will be

$$R = \frac{4 - 1}{0.5} = 6.$$

Because the R value is greater than the mean frequency by at least the standard deviation (R>Fₘₑₐₙ+StdDevₘₑₐₙ), the targeted user purchases items belonging to the category spa services more often than the average male user. Thus a larger value indicates a more significant statistical relevance. If R is within the standard deviation, then there is no statistical relevance between the attributes. If R<Fₘₑₐₙ−StdDevₘₑₐₙ, then the targeted user has a lower than average probability of purchasing the item, based on the attributes that were compared. The statistical relevance can be calculated for a number of item attribute and user attribute pairs to allow the determination of which item attributes are more statistically relevant to a particular user. These item attributes can then be used to determine what items to recommend to the user.

In another embodiment, the item attributes associated with the interacted items can be analyzed, as described above, to determine the value of R for one or more item attributes. Item attributes with statistically significant R values can be used in subsequent analysis. As a user can interact with various different items, the items can be first grouped into similar items. Items can also be filtered based upon a client's business rules or based upon data from the client. For example, a client that is a spa can limit the items analyzed to those that are related to spas. In one implementation, this can be done by limiting the items to those that are associated with a spa service. For each item or for each group of items, the item attributes with statistically significant R values can be determined as described above. For example, the item attributes that are in common with a statistically significant amount of items can be determined. Those item attributes can be the set of item attributes used to calculate the various R values for item attribute and user attribute pairs. For example, if the user has previously clicked on various pages concerning extra large t-shirts of a particular brand, has purchased these t-shirts from one or more clients, and has posted a comment about the particular brand to a social media website, the statistically significant item attributes can be determined as type of product is a t-shirt, the size is extra large, and the brand is the particular brand. By using the R values described above, the server 202 can determine that these three item attributes are relevant to the user compared to the population of users. For example, the targeted user could be female and the R value for females who buy extra large t-shirts can indicate that this targeted user has a statistically relevant interest in extra large t-shirts. As another example, the targeted user can be 30 years old and the R value for users that are 30 or in an age range that includes 30 that purchase the particular brand of products can indicate that this targeted user has an interest in the particular brand that is greater than the population of users that are 30. Accordingly, a client that sells t-shirts can use these item attributes to determine which of their products they should recommend to the user. For example, extra large t-shirt from the particular brand would be highly recommended if available. In addition, other products from the particular brand and/or extra large t-shirts from another brand could also be recommended. The procedure 408 can rank all items provided to the procedure in order of most relevant to least relevant, based on the R value.

The compare user attributes to item attributes procedure 410 can determine the mean purchasing frequency for an item with one or more item attributes by a user with one or more user attributes. In one implementation, the frequency of item attribute and user attribute matches in transactions can be determined. For example, the server 202 can calculate the Fₘₑₐₙ, as described above. Thus, the server can determine the user attributes and items attributes that are highly related to each other and those which have a passing relation. For example, the server 202 may determine that a user attribute indicating an income level above $100,000 and items belonging to spa services category have an Fₘₑₐₙ=7. Therefore, the average user earning more than $100,000 purchases seven items belonging to the spa services category over a period of time. Conversely, the server 202 may determine that, no matter which state the average user lives in, the average user purchases approximately the same number of items belonging to a spa services category. Thus, the server 202 can determine the relevance of an item belonging to a spa services category to a targeted user by analyzing the income attribute of the targeted user, but can ignore the state user attribute as not being relevant. If the targeted user earns more than $100,000, then the system can estimate that the targeted user will purchase seven items belonging to a spa services category over a period of time. The same calculation can be done for all available items.

In another embodiment, the server 202 may calculate the Fₘₑₐₙ over multiple attributes of the user and of the item. For example, the server 202 may calculate the Fₘₑₐₙ for user attribute gender and the Fₘₑₐₙ for user attribute age. For example, if the Fₘₑₐₙ of a shirt item is being calculated for male users who are 35 years old, the server can determine an Fₘₑₐₙ for male users and items belonging to the category shirt. Similarly, the server 202 can calculate the Fₘₑₐₙ for 35 year olds and items belonging to the category shirt. The server 202 can combine the two values to determine an overall Fₘₑₐₙ. The overall Fₘₑₐₙ can be used to rank the relevance of the item to the targeted user. Because items with the highest Fₘₑₐₙ are likely to be purchased more often by the targeted user than items with lower Fₘₑₐₙ values, the system 202 can rank the items based on the Fₘₑₐₙ value. The server 202 can assign weights to each of the attributes and the Fₘₑₐₙ values. Based on the weights, individual Fₘₑₐₙ values for the attributes can be combined to form an overall mean purchasing frequency for an average user with the selected attribute values. In another embodiment, results from the procedures 408 and 410 can be combined together.

The compare user to second user procedure 412 determines the relevance of an item to a second user that is similar to the targeted user. In an embodiment, the server 202 can search for a second user with similar attributes to the targeted user. For example, the server 202 may rank all users based on the number of attributes that match between the targeted user and the second user. The user with the most attributes matching the can be selected as the second user. In another embodiment, the attributes may be weighted differently. For example, the gender attribute may be less important than the income attribute. Therefore, a match on the income attribute may be more favorable than a match on gender. The server 202 can query the second user's transactions to determine the relevance of available items to the targeted user.

Each of procedures 408, 410, and 412, can determine statistically relevant attributes, e.g., user attributes, item attributes, etc. The procedures 408, 410, and 412 can treat attributes differently. For example, certain attributes can be weighted more or less. On one embodiment, the client can specify which attributes should have a higher weighting. For example, a client may wish to move a particular type of inventory, e.g., high margin items, clearance items, a particular location, etc. In this example, when a statistically relevant attribute matches, this attribute can be weighted accordingly. As another example, particular attributes can be ignored all together. As an example, the color of a t-shirt could be ignored.

The retrieve top recommendations for client 416 procedure can retrieve the items with the most transactions for a client. In an embodiment, the server 202 can query transactions in the transactions data structure 306 to determine the most purchased items for the client. The server 202 can then use the most purchased items as recommended items for the targeted user. In another embodiment, a client's items that have the most interactions, e.g., clicks, reviews, purchases, etc., can be chosen. In another embodiment, some attribute matching can occur. For example, a client's items that have the most purchases by men can selected for a targeted user that is a male.

The recommendation engine 314 can include a plurality of recommendation procedures. A recommendation procedure may be enabled or disabled for one or more clients. In an embodiment, the server 202 can determine the availability of one or more recommendation procedures based on a client. For example, the client may have elected not to pay for a premium recommendation procedure. Therefore, even if the server 202 has sufficient data to generate recommendations from a premium procedure, the server 202 can disable the procedure because the client has opted not to use the procedure. Similarly, the client can manually opt-in or out of using specific recommendation procedures.

In another embodiment, the recommendation engine 314 can rank available items using one or more recommendation procedures. The server 202 can determine the relative weight that should be assigned to each recommendation procedure. For example, one recommendation procedure's ranking may be of less value because the procedure uses the user's transaction history and the targeted user does not have a lengthy transaction history. In another example, a second recommendation procedure's ranking may be of more value because the recommendation procedure is optimized for a specific item category. For example, a recommendation procedure that ranks spa services for users may be weighted more heavily if all of the items being ranked are within the category of spa services. In a further example, the recommendation procedures can be ranked based on additional factors, such as, but not limited to, the diversity of recommendations, purchase curve conformity, purchase maximization, and revenue maximization. Thus, a first recommendation procedure that has a high diversity of products but yields a low number of purchases may be ranked lower than a second recommendation procedure that recommends items that are more likely to be purchased. The weights assigned to additional factors can vary based on business rules, client requirements, product inventory, etc. Thus, if a client prefers to maximize diversity over probability of an item being purchased, a recommendation procedure with high diversity will be weighted more favorably.

The recommended content generator 316 can generate a variety of content types based upon the results of the recommendation engine 314. In an embodiment, the recommended content generator 316 generates email directed to users. For example, the client can request that its users receive a mailing with recommended items. The server 202 can direct the recommended content generator 316 to generate content for users based on the results output by the recommendation engine 314. For example, example, numerous recommendations can be provided by the recommendation engine 314 using one or more of the procedures described above. Therefore, the server can generate a list of top recommended items for the targeted user. In another example, the recommendation engine can provide a single recommendation. In this example, the server generates an email with detailed information related to the single recommendation.

In another embodiment, the recommended content generator 316 can generate responses to micro-blog entries. For example, the server 202 can identify social media data that the server 202 can respond to on behalf of a client. The server 202 can direct the recommended content generator to generate a micro-blog response directed at the original micro-blog entry based on the results output by the recommendation engine 314 as described in greater detail below.

In another embodiment, the recommended content generator 316 can generate optimized webpages for a client. For example, the server 202 can receive a request from a client to display an optimized webpage for a user. The server 202 can direct the recommended content engine to generate a webpage using content generated by the recommendation engine 314 as described in greater detail below.

Generating Targeted Email

FIG. 5 depicts a flowchart of a method 500 for generating targeted email content to be delivered to users on behalf of a client. Additional, fewer, or different operations can be performed, depending on the embodiment. The method 500 can be implemented on a computing device. In one implementation, the method 500 is encoded on a computer readable medium that contains instructions that, when executed by a computing device, cause the computing device to perform operations of the method 500.

Email content can be generated using one or more of the recommendation engine procedures described above. In one implementation, described below, the method 500 uses the compare user transaction history to item attributes procedure 408. In an operation 502, the server 202 can receive a request to send email to one or more users. For example, the server 202 can receive a request from a client to send targeted email to users. In another example, the server 202 can determine that email should be sent for a client to the users. For example, the server 202 can process business rules 312 to determine that one or more of the client's users should receive emails once every week. Thus, the server 202 can also initiate a request to generate email for users based on business rules 312 and the processed data 302.

In an operation 504, the server 202 can retrieve items associated with the client. For example, the server can query the items data structure 308 to retrieve items that the client has in its inventory. As another example, the items can expressly be provided by the client through the business rules. The business rules can indicate what items should be considered. For example, the items can be those that the client wishes to promote, items with a high profit margin, etc. In an operation 506, the server 202 can retrieve all past transactions by a targeted user, which is one of the users that will receive a targeted email. The server 202 can retrieve transactions between the targeted user and all available clients or the server 202 may filter transactions based on business rules, item attributes, or client attributes. For example, if all items sold by a client belong to a spa services category, then the retrieved transactions may be limited to the spa services category or to other categories that are related to spa services.

In an operation 508, the server 202 can determine the relevance of each retrieved item to the targeted user by analyzing items the targeted user has previously bought. The server 202 can determine the Fₘₑₐₙ for each item attribute of each retrieved item in the transaction history of each targeted user. For example, if the available items comprise shirts in red, blue, and green colors, the server can determine the Fᵤₛₑᵣ value of each color to the transaction history of the targeted user. For example, if the available items are red shirts, blue shirts, and green shirts, the server 202 can determine how many of the targeted user's previous transaction across all clients, over a period of time, were for red shirt items, how many transactions were for green shirt items, and how many transactions were for blue shirt items. By retrieving the targeted user's transaction history, the server 202 can determine the Fᵤₛₑᵣ for each shirt color. For example, the server 202 can determine Fᵤₛₑᵣ for red shirts is three (F_{user(red)}=3), the Fᵤₛₑᵣ for green shirts is 10 (F_{user(green)}=10) and the Fᵤₛₑᵣ for blue is ten (F_{user(blue)}=10). Thus, the server 202 can determine that the user prefers blue and green shirts.

In an operation 509, the server 202 can determine the mean number and the standard deviation of items bought over a period of time with each item attribute of the available items over the population of all of the users (i.e., the Fₘₑₐₙ and the StdDevₘₑₐₙ). For example, the server 202 can determine the average purchasing frequency and the standard deviation for the average user with one or more user attributes in common with the target user. Thus, if the target user is male, the server 202 may determine the average purchasing frequency for blue, green, and red shirts for all males in the system. Using the procedure described above, the server 202 can calculate the following values:

F_{mean(red)}=7 and StdDev_{mean(red)}=1;

F_{mean(green)}=2 and StdDev_{mean(green)}=0.5;

F_{mean(blue)}=10 and StdDev_{mean(blue)}=1;

The server 202 can then calculate the R value for each of the colors for the targeted user using the equation described above. Thus, the R values can be:

$${R}_{red} = \frac{3 - 7}{1} = - 4$$

$${R}_{green} = \frac{10 - 2}{0.5} = 16$$

$${R}_{blue} = \frac{10 - 10}{1} = 0$$

Thus, although the targeted user prefers green and blue equally, the server 202 can determine, based on the R values, that the targeted user is far more likely to purchase a green shirt, when compared to the average male user. Similarly, the targeted user is far less likely to buy a red shirt, when compared to the average male user and is equally likely to by a blue shirt, when compared to the average male user.

The number of user attributes and item attributes can be quite large. To determine statistical relevancies that are useful in recommending items, the server 202 can calculate the statistical relevance for each item attribute and user attribute pair. In the above example, not only would the statistical relevance for color of shirts purchased by male users be calculated, but the statistical relevance for each item attribute and user attribute pair derived from the target user's user attributes and the item attributes from the available items. In other embodiments, only certain user attributes and item attributes are used in calculating the statistical relevance. For example, item attributes that are not available for a predetermined number of items can be ignored. Once the statistical relevance for each pair of attributes is calculated, the statistical relevancies can be normalized and then ranked to determine which item attribute and user attribute pairs provide an indication of the targeted user is different than the normal population. In the above example, the user's preference for green could be determined. Items that match the item attributes for one or more of the top ranking statistical relevance scores can be recommended to the user.

In an operation 510, the server can rank the available items based on one or more R values determined in operation 509. For example, the server 202 can select the items with the highest R values as recommended items. The R values associated with a particular item can be determined in a number of ways. In one embodiment, the highest R value that matches the item is used as the item's R value. In another embodiment, item attributes for a particular item can be matched with multiple R values to determine a composite relevance score. For example, a first item can match two R values based upon the item's attributes. Another item can match a single R value based upon the item's attributes and the item attribute associated with the single R value. The first item's relevance score can be calculated based upon the two matching R values, e.g., summing, weighted average, etc. The items can then be ranked on their composite relevance scores. In another implementation, the server can skip some statistically relevant items based on, for example, purchasing curves or lack of diversity. For example, because R_{red} is well below average, the targeted user is unlikely to purchase a red shirt. If however, the F_{user(red)} increases to 20 during the months of January and February, the server 202 can recommend red shirts to the targeted user during the months of January and February because the user is more likely to purchase a red shirt in that time frame.

In another example, the server 202 can determine that the diversity among the recommended items is very low. The server 202 can determine that a majority of recommended items are very similar to each other. Thus, the server can lower the ranking of highly relevant items to introduce diversity in the items that will be recommended to the user. For example, if one of three items (e.g., a red shirt, a blue shirt, and a green shirt) can be recommended to each user, the server 202 can adjust the recommendations to comport with purchasing distributions. If red shirts, blue shirts, and green shirts are purchased 10, 20, and 70 percent of the time, respectively, then the items can be recommended in approximately the same percentages as the purchasing curves. Thus red shirts can be recommended approximately 10 percent of the time and green shirts can be recommended approximately 70 percent of the time. If the server 202 determines that red shirts are being recommended, for example, 40 percent of the time, the server 202 can normalize the results from a recommendation procedure so that the diversity of items falls within a range, such as two, three or four, standard deviations from the purchase distribution of the item. Thus, the probability of a red shirt being recommended can be normalized so that it does not deviate from 10 percent beyond, for example, two standard deviations.

In an operation 512, the server 202 can generate email content using recommended items provided by operation 510 for the targeted users. For example, the operation 512 can generate email incorporating the images and descriptions of recommended items in a previously determined format. The operation 512 can iterate over all recommended items received from operation 510 and determine the format of the generated content. For example, if the recommended items included in operation 510 are only blue and green shirts, then the content of the email can be focused on a broad category. Thus, for example, the subject of the email can be “weekend sale on shirts.” If, however, the recommended items are only red shirts, the content of the generated email may be similarly narrow. Thus, the subject can be “weekend sale on red shirts.” In another example, if multiple recommended items are returned, then the email content may include a list of items with a short description for each item. If, however, only one item is recommended, then the generated content can have a detailed description of the recommended item

In another embodiment, operation 512 can receive recommended items from operation 510, such that some recommended items are layout items and others are client products. For example, operation 512 may receive two recommended layout items, such that the first layout item indicates that an image for the most recommended item should be positioned in the top left area of the email body and the second layout item indicates that the image for the second most recommended item should be positioned on the top right.

In another embodiment, operation 512 can evaluate the recommended items and determine an optimal layout for the email. For example, the recommended content can include a series of images with varying image sizes and varying lengths of text. The operation 512 can determine the optimal spacing for an email of an optimal size. For example, if an email is likely to be read on a mobile phone, the operation 512 can choose smaller images. In contrast, if the email is likely to be read on a large screen, the operation 512 can choose larger images and also can include text. The operation 512 can iterate over all targeted users and generate targeted email for each user.

In an operation 514, the server 202 can retrieve the email address associated with the targeted user. In an operation 516, the server 202 send the targeted email to the targeted user, with content targeted to the targeted user. Operations 506-516 can be repeated for each user identified in operation 502, such that each identified user receives a targeted email based upon each identified user's transactions. In an embodiment, the server 202 can determine the time that the email should be sent. For example, the server 202 can analyze attributes associated with the targeted user and determine which day and time the user is most likely to open and read an email received from a client. As an example, the transactions data structure 306 can include transactions describing when a user opens an email. These transactions can be analyzed in as similar manner as described above to determine when a user is more likely to open an email. Thus, the server 202 can schedule delivery of the email based on the probability of the user reading the email.

Generating Recommended Micro-Blog Entries

FIG. 6 is a flow diagram of a method 600 for responding to a micro-blog entry with automatically generated response to a micro-blog entry with recommended content in a representative embodiment. Additional, fewer, or different operations of the method 600 can be performed, depending on the particular embodiment. The method 600 can be implemented on a computing device. In one implementation, the method 600 is encoded on a computer-readable medium that contains instructions that, when executed by a computing device, cause the computing device to perform operations of the method 600.

Responses to a micro-blog entry can be generated using one or more recommendation engine procedures described above. In one implementation, described below, method 600 uses the compare user attributes to item attributes 410 procedure. In an operation 602, the server 202 identifies a micro-blog entry that can be replied to. For example, the server 202 can request targeted micro-blog entries from a social media data source 204 containing one of a set of terms. The server 202 can then determine that a response to one or more of the targeted entries should be generated.

In an operation 604, the targeted user that posted the targeted entry is identified. For example, the micro-blog entry can include the email address of the targeted user. The server 202 can then query previously processed data 302 to determine if any users in the users data structures 304 are related to the email address of the targeted user.

In an operation 606, the user attributes of the identified user are retrieved. In an operation 608, the items available for recommendation are retrieved. For example, the server 202 can retrieve all items that the client is currently selling. In another example, the server 202 may determine which items are meeting their sales targets and exclude those from the available items. As another example, the items retrieved can be based upon an analysis of the micro-blog entry. For example, natural language processing can be done on the micro-blog entry to determine that the micro-blog entry is directed toward a vehicle. Additionally, it can be determined that the micro-blog entry is directed toward purchasing a vehicle. Using this information, the items retrieved can be limited to those that are a vehicle or are associated with a vehicle.

In an operation 610, the server 202 can determine the average purchasing frequency for each pair of item attributes and user attributes for the available items and the identified user. For example, if the targeted user is male and the available items comprise of a family car, a luxury car, and a sports car, the server 202 can determine the average purchasing frequency (Fₘₑₐₙ) for each of the categories of cars. For example, the server 202 may determine that the average male purchases an average of three family cars over a period of time (F_{mean(family)}=3), two luxury cars over the same period of time (F_{mean(luxury)}=2), and one sports car over the same period of time (Fₘₑₐₙ₍ₛₚₒᵣₜₛ₎=1). The server 202 can determine the average purchasing frequency of each item on additional item and targeted user attributes, for example the price of the car and the income of the targeted user, and determine an overall statistical relevance, as described above, for each item.

In an operation 612, the server 202 can determine the statistical relevance of each available item to the content of the micro-blog entry. For example, if the micro-blog entry mentions a luxury car, then the server can determine that the micro-blog entry is about luxury cars and can categorize it as such. The server 202 can rank the categorized micro-blog entry attributes with the item attributes in the same manner as discussed above.

In an operation 614, the server 202 can then determine the overall statistical relevance of items based on operations 610 and 612. For example, the server 202 may rank the available items based on the Fₘₑₐₙ values calculated by operation 610. Additionally, the server 202 may weight the ranking based on the micro-blog entry attributes determined in operation 612. For example, if the micro-blog entry is determined to have a topic of luxury cars, then the server 202 can weight the luxury car ranking more than the other two car types. In addition, the relevance of items can be determined as a composite of statistical relevance of item attributes to user attributes as described above in FIG. 5. As previously described, the server 202 can skip some statistically relevant items based on, for example, purchasing curves or lack of diversity.

In an operation 616, content for a response to a micro-blog entry is generated using one or more of the recommended items selected in operation 614. In an embodiment, the operation 616 can generate a micro-blog response that includes a short comment directing the targeted user that posted the micro-blog entry to visit a website. The micro-blog response can further include a URL to direct the user to the website.

In an operation 618, the generated content is posted as a reply to the micro-blog entry identified in the operation 602. In an embodiment, the server 202 can determine the time that the micro-blog response should be posted. For example, the server 202 can analyze attributes associated with the targeted user and determine which day and time the user is most likely to read responses to micro-blog entries. For example, the server 202 can determine the time of the original entry and the time of any replies the targeted user posted on the micro-blog site.

Generating Website Content

FIG. 7 depicts a flowchart of a method 700 for generating website content for a client. Additional, fewer, or different operations can be performed, depending on the embodiment. The method 700 can be implemented on a computing device. In one implementation, the method 700 is encoded on a computer readable medium that contains instructions that, when executed by a computing device, cause the computing device to perform operations of the method 700.

Website content can be generated using one or more of the recommendation engine procedures described above. In one implementation, described below, the method 700 uses the retrieve top recommendations for client 416 procedure. In an operation 702, the server 202 can receive a request to generate optimized website content for a targeted user. For example, the client can request an optimized recommended items page for the targeted user, such that items relevant to the targeted user are displayed.

In an operation 704, the server 202 can retrieve all available items for a client. For example, the server can query the items data structure 308 to retrieve items that the client has in its inventory. In an operation 706, the server 202 can retrieve all past transactions by all users with the client. The server 202 can retrieve transactions within a date range or the server 202 can filter transactions based on business rules or item attributes. For example, if all the user is requesting a page with an emphasis on t-shirts, then the retrieved transactions may be limited to the then only items that belong to the category t-shirt or to other related categories.

In an operation 708, the server 202 can rank the available items based on the number of transactions retrieved in operation 706. For example, the server can rank the available items based on how often the items have been purchased. In an operation 710, the server 202 can select the most purchased items as recommended items, or, as discussed above, the server 202 can skip some items based on, for example, purchasing curves or lack of diversity. The recommended items can additionally include layout items. For example, the server 202 can determine the most relevant areas of the screen by determine which areas of the screen the user is most likely to click on.

In an operation 712, content for the website is generated using one or more of the recommended items selected in operation 710. For example, the server 202 can generate an HTML page displaying a first recommended item. The first recommended item can be positioned in a location that relates to a high click-thru ratio for the targeted user, or for users with attributes similar to the targeted user.

In an operation 712, the generated content is displayed to the user. In one embodiment, the generated page can be returned to the client and served to the user by the client. In another embodiment the server 202 can serve the page to the user. It will be apparent to one skilled in the art that the generated page can be an intermediate page. For example, the server 202 can generate a PHP or JAVA Server Page which is then rendered by the client. It will further be apparent to one skilled in the art that content delivered to a user can be generated and rendered in a multitude of technologies.

FIG. 1 is a block diagram of a computing device 100 which can be used to implement the systems and methods in accordance with the implementations described herein, as either a client or as a server or plurality of servers. Computing device 100 can include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and can be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses can be used, as appropriate, along with multiple memories and types of memory. Also, multiple computing devices 100 can be connected, with each device providing portions of the necessary operations (e.g., as a server bank, a group of blade servers, a multi-processor system, etc.). The ports 108, which can include various communication ports (e.g., USB, Bluetooth, Ethernet, wireless Ethernet, etc.), can be coupled to one or more input/output devices, such as a keyboard, a mouse, a pointing device, a scanner, etc., or a networking device (a switch, adapter, bridge, router, hub, repeater, etc.).

The processor 102 can provide, for example, for coordination of the other components of the device 100, such as control of user interfaces, applications run by device 100, and wireless communication by device 100. Processor 102 can communicate with a user via interface 106 (e.g., control, display, external, etc.), coupled to a display 110. The display 110 can be, for example, a TFT (Thin-Film-Transistor Liquid Crystal Display) display, an OLED (Organic Light Emitting Diode) display, other flexible display, etc. The interface 106 can include circuitry for driving the display 110 to provide graphical, textual, and other information to a user. The interface 106 can receive commands (e.g., voice-activated, text, etc.), from a user and convert them to provide to the processor 102.

In addition, the interface 106 can be provided to communicate with processor 102 and enable near area communication of device 100 with other devices. The interface 106 can provide, for example, for wired communication. In some implementations, multiple interfaces can be used. Computing device 100 can communicate wirelessly through interface 106, which can include digital signal processing circuitry where necessary. Interface 106 can provide for communications under various modes or protocols, such as GSM voice calls, SMS, EMS, or MMS messaging, CDMA, TDMA, PDC, WCDMA, CDMA2000, or GPRS, etc. Such communication can occur, for example, through a radio-frequency transceiver. In addition, short-range communication can occur, such as using a Bluetooth, WiFi, or other such transceiver. In addition, GPS (Global Positioning System) receiver module can provide additional navigation- and location-related wireless data to device 100, which can be used as appropriate by applications running on device 100. The device 100 can also be provided with a storage device to provide additional storage, e.g., solid-state flash media. Each of the components can be interconnected using various buses. Several of the components can be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 can also be another form of computer-readable medium, such as a magnetic or optical disk. The memory 104 can be capable of providing mass storage for the computing device 100. In one implementation, the memory 104 can be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product can be tangibly embodied in an information carrier. The computer program product can also contain instructions that, when executed, perform one or more methods, such as those described below. The information carrier is a computer or machine-readable medium, such as the memory 104, memory on processor 102, etc. Expansion memory can be provided and connected to device 100 through interface 106. The processor 102 and memory 104 or other memory (e.g., inside the processor) can form a processing circuit or processing module for completing the activities described herein.

What is claimed is:

1. A method comprising:
receiving, at a computing device, external data from one or more data sources;
processing the external data to generate processed data, wherein the processed data is stored at the computing device;
determining available items of a first client, wherein each item has item attributes;
retrieving user transactions associated with a targeted user having user attributes including a user identifier, wherein each user transaction comprises an item identifier and a user identifier, and wherein the user transactions comprise one or more transactions involving a second client different than the first client;
pairing each user attribute of the targeted user with each item attribute of the available items;
determining a user mean purchasing frequency for each of the pairs of user attribute and item attribute;
retrieving one or more user attribute values of the targeted user;
for each of the one or more user attribute values, retrieving global transactions of a population of users that have a user attribute value that is equal to the each of the one or more user attribute values;
for each of the global transactions, determining a standard deviation and a global mean purchasing frequency for each of the pairs of user attribute and item attribute from each of the global transactions;
calculating a relevance score for each of the pairs of user attribute and item attribute based at least on the user mean purchasing frequency, the global mean purchasing frequency and the standard deviation;
determining an item relevance score, for each available item, based upon one or more relevance scores that match an item attribute of the available item; and
selecting one or more available items of the first client based upon relevance scores of the available items.

2. The method of claim 1, further comprising generating targeted content, wherein the targeted content is directed to the targeted user, and wherein the targeted content incorporates information relating to the selected one or more available items.

3. The method of claim 2, further comprising sending the targeted content to the targeted user.

4. The method of claim 3, wherein the targeted content comprises email.

5. The method of claim 4, further comprising determining a first time to send the targeted content to the targeted user, wherein the first time is based on transactions involving interaction with email associated with the targeted user, and wherein the targeted content is sent as the first time.

6. The method of claim 1, further comprising filtering the available items of the first client based upon one or more business rules.

7. The method of claim 1, wherein calculating the relevance score comprises:
subtracting the global mean frequency subtracted from the user mean frequency to generate a result; and
dividing the result by the standard deviation.

8. A system comprising:
one or more processors configured to:
receive external data from one or more data sources;
process the external data to generate processed data, wherein the processed data is stored at a server;
determine available items of a first client, wherein each item has item attributes;
retrieve user transactions associated with a targeted user having user attributes including a user identifier, wherein each user transaction comprises an item identifier and a user identifier, and wherein the user transactions comprises one or more transactions involving a second client different than the first client;
pair each user attribute of the targeted user with each item attribute of the available items;
determine a user mean purchasing frequency for each of the pairs of user attribute and item attribute;
retrieve one or more user attribute values of the targeted user;
for each of the one or more user attribute values, retrieve global transactions of a population of users that have a user attribute value that is equal to the each of the one or more user attribute values;
for each of the global transactions, determine a standard deviation and a global mean purchasing frequency for each of the pairs of user attribute and item attribute from each of the global transactions;
calculate a relevance score for each of the pairs of user attribute and item attribute based at least on the user mean purchasing frequency, the global mean purchasing frequency and the standard deviation;
determine an item relevance score, for each available item, based upon one or more relevance scores that match an item attribute of the available item; and
select one or more available items of the first client based upon relevance scores of the available items.

9. The system of claim 8, wherein the one or more processors are further configured to generate targeted content, wherein the targeted content is directed to the targeted user, and wherein the targeted content incorporates information relating to the selected one or more available items.

10. The system of claim 9, wherein the one or more processors are further configured to send the targeted content to the targeted user.

11. The system of claim 10, wherein the targeted content comprises email.

12. The system of claim 11, wherein the one or more processors are further configured to determine a first time to send the targeted content to the targeted user, wherein the first time is based on transactions involving interaction with email associated with the targeted user, and wherein the targeted content is sent as the first time.

13. The system of claim 8, wherein the one or more processors are further configured to filter the available items of the first client based upon one or more business rules.

14. The system of claim 8, wherein the relevance score is calculated by the one or more processors configured to:
subtract the global mean frequency subtracted from the user mean frequency to generate a result; and
divide the result by the standard deviation.

15. A non-transitory computer-readable medium having instructions stored thereon, wherein the instructions comprise:
instructions to receive external data from one or more data sources;
instructions to process the external data to generate processed data, wherein the processed data is stored at a server;
instructions to determine available items of a first client, wherein each item has item attributes;
instructions to retrieve user transactions associated with a targeted user having user attributes including a user identifier, wherein each user transaction comprises an item identifier and a user identifier, and wherein the user transactions comprises one or more transactions involving a second client different than the first client;
instructions to pair each user attribute of the targeted user with each item attribute of the available items;
instructions to determine a user mean purchasing frequency for each of the pairs of user attribute and item attribute;
instructions to retrieve one or more user attribute values of the targeted user;
instructions to for each of the one or more user attribute values, retrieve global transactions of a population of users that have a user attribute value that is equal to the each of the one or more user attribute values;
instructions to for each of the global transactions, determine a standard deviation and a global mean purchasing frequency for each of the pairs of user attribute and item attribute from each of the global transactions;
instructions to calculate a relevance score for each of the pairs of user attribute and item attribute based at least on the user mean purchasing frequency, the global mean purchasing frequency and the standard deviation;
instructions to determine an item relevance score, for each available item, based upon one or more relevance scores that match an item attribute of the available item; and
instructions to select one or more available items of the first client based upon relevance scores of the available items.

16. The non-transitory computer-readable medium of claim 15, wherein the instructions further comprise instructions to generate targeted content, wherein the targeted content is directed to the targeted user, and wherein the targeted content incorporates information relating to the selected one or more available items.

17. The non-transitory computer-readable medium of claim 16, wherein the instructions further comprise instructions to send the targeted content to the targeted user.

18. The non-transitory computer-readable medium of claim 17, wherein the targeted content comprises email.

19. The non-transitory computer-readable medium of claim 18, wherein the instructions further comprise instructions to determine a first time to send the targeted content to the targeted user, wherein the first time is based on transactions involving interaction with email associated with the targeted user, and wherein the targeted content is sent as the first time.

20. The non-transitory computer-readable medium of claim 15, wherein the instructions further comprise instructions to filter the available items of the first client based upon one or more business rules.
